(19) United States
(12) Patent Application Publication
(10) Pub. No.: US 2024/0106779 A1
(43) Pub. Date: Mar. 28, 2024

(54) SYSTEMS AND METHODS FOR USER-SPECIFIED EXCHANGE FOR MESSAGE CHANNEL DATA

(71) Applicant: Yahoo Ad Tech LLC, New York, NY (US)

(72) Inventors: Eric BAX, Sierra Madre, CA (US); Kimberly WILLIAMS, Burbank, CA (US); Melissa GERBER, Rancho Mission Viejo, CA (US); Tanisha SHARMA, Los Angeles, CA (US); Will WAGNER, Costa Mesa, CA (US); Nikki THOMPSON, New York, NY (US); Lisa GIAFFO, Pasadena, CA (US)

(21) Appl. No.: 17/934,639

(22) Filed: Sep. 23, 2022

(51) Int. Cl. H04L 51/21; H04L 51/06

(52) U.S. Cl. CPC H04L 51/21; H04L 51/06

(57) ABSTRACT

A method includes receiving inputs from a plurality of data providers reflecting the plurality of data providers' respective parameters for providing message channel data; receiving inputs from a plurality of data recipients reflecting the data recipients' respective parameters for receiving message channel data; identifying, using a matching engine, message channel data that matches the parameters of at least one of the plurality of data providers and the parameters of at least one of the data recipients; processing the message channel data in accordance with the parameters of the data providers, the processing step comprising segmenting the message channel data into permitted data segments and non-permitted data segments based on the data providers' parameters; delivering the permitted data segments to the identified data recipients in accordance with their respective parameters; and initiating a request for compensation of the identified data providers in accordance with their respective parameters.

### TECHNICAL FIELD

The present disclosure relates generally to systems and methods for providing user-specified exchanges for message channel data. More particularly, and without limitation, the present disclosure relates to systems and methods for providing users with the ability to set parameters on the types of data that are available to data recipients in an online environment.

### BACKGROUND

Message channel data, for example, email and text message data, can be valuable to parties that neither send nor receive the messages. Emails may contain receipts that indicate which businesses may be growing or shrinking, message topics may indicate when and where infectious diseases are spreading, and message sentiment can indicate increasing or decreasing popularity of various subjects, for example. However, email and text messaging users generally desire to maintain their privacy, and many of them would also appreciate profiting from the value of their data.

Message channel data may have significant value to interested parties. Message channel data includes information that can elucidate an individual's interests and activities that may, for example, help an advertiser determine what kind of advertisements the user will be interested in. When aggregated with the data of other users, the combined message channel data may demonstrate patterns that are of interest to a variety of parties, such as government agencies, businesses looking to expand and advertise, etc.

To be of value to the interested parties, there may be specific parameters required that the message channel data offer. For example, if a party is interested in identifying where disease is spreading, they may require geolocation data, and the inclusion of specific words or phrases related to infectious disease, such as “covid” or “cough medicine” or “sore throat,” and messages that include receipts from drug stores or pharmacies.

Users of online content, however, are increasingly privacy-conscious and protective of their data. They may be unwilling to share all the information a prospective buyer of data requires for their purposes, making it difficult to match available message channel data with the needs of buyers. For example, some users may be unwilling to share geolocation data, while others may be unwilling to share personally identifiable information. Some users may further be unwilling to share data unless it is aggregated with the data of at least a specified number of other users, while still others may be unwilling to share their data at all. To the extent users are willing to share their data, they are also increasingly interested in being compensated for that data.

As such, a need exists to match the message channel data requests of potential buyers, also referred to as data recipients, with users who consent to the parameters required by the requests of the data recipients.

### SUMMARY

Various embodiments of the present disclosure relate generally to improving methods for providing user-specified exchanges for message channel data. Each of the embodiments disclosed herein may include one or more of the features described in connection with any of the other disclosed embodiments.

According to some embodiments, computer-implemented methods are disclosed for providing user-specified exchanges for message channel data. In one exemplary method, the method includes receiving, using at least one processor, inputs from the plurality of data providers reflecting the plurality of data providers' respective parameters for providing message channel data; receiving, using the at least processor, inputs from the plurality of data recipients reflecting the data recipients' respective parameters for receiving message channel data; identifying, using a matching engine, message channel data that matches the parameters of at least one of the plurality of data providers and the parameters of at least one of the data recipients; communicating the match to the data recipients whose parameters were identified in the match; collecting the message channel data that was identified in the match; processing the message channel data in accordance with the parameters of the data providers whose parameters were identified in the match, the processing step comprising segmenting the message channel data into permitted data segments and non-permitted data segments based on the data providers' parameters; delivering the permitted data segments to the identified data recipients in accordance with their respective parameters; and initiating a request for compensation of the identified data providers in accordance with their respective parameters.

According to certain embodiments, systems are disclosed for providing user-specified exchanges for message channel data. One system includes a data storage device storing instructions for receiving, using at least one processor, inputs from the plurality of data providers reflecting the plurality of data providers' respective parameters for providing message channel data; receiving, using the at least processor, inputs from the plurality of data recipients reflecting the data recipients' respective parameters for receiving message channel data; identifying, using a matching engine, message channel data that matches the parameters of at least one of the plurality of data providers and the parameters of at least one of the data recipients; communicating the match to the data recipients whose parameters were identified in the match; collecting the message channel data that was identified in the match; processing the message channel data in accordance with the parameters of the data providers whose parameters were identified in the match, the processing step comprising segmenting the message channel data into permitted data segments and non-permitted data segments based on the data providers' parameters; delivering the permitted data segments to the identified data recipients in accordance with their respective parameters; and initiating a request for compensation of the identified data providers in accordance with their respective parameters.

Another system includes a memory having processor-readable instructions stored therein and a processor configured to access the memory and execute the processor-readable instructions, which when executed by the processor configure the processor to perform a method. In one exemplary method, the method includes receiving, using at least one processor, inputs from the plurality of data providers reflecting the plurality of data providers' respective parameters for providing message channel data; receiving, using the at least processor, inputs from the plurality of data recipients reflecting the data recipients' respective parameters for receiving message channel data; identifying, using a matching engine, message channel data that matches the parameters of at least one of the plurality of data providers and the parameters of at least one of the data recipients; communicating the match to the data recipients whose parameters were identified in the match; collecting the message channel data that was identified in the match; processing the message channel data in accordance with the parameters of the data providers whose parameters were identified in the match, the processing step comprising segmenting the message channel data into permitted data segments and non-permitted data segments based on the data providers' parameters; delivering the permitted data segments to the identified data recipients in accordance with their respective parameters; and initiating a request for compensation of the identified data providers in accordance with their respective parameters.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate exemplary embodiments of the present disclosure and, together with the description, serve to explain the principles of the disclosure.

FIG. 1 shows a block diagram of an exemplary online advertising environment for providing user-specified exchanges for message channel data, consistent with exemplary embodiments;

FIG. 2 shows a block diagram of an exemplary server system for providing user-specified exchanges for message channel data, consistent with exemplary embodiments of the present disclosure;

FIG. 3 is a flow diagram of an exemplary method for providing user-specified exchanges for message channel data in an online advertising environment, according to an embodiment of the present disclosure;

FIG. 4 is an exemplary screenshot of a graphical user interface for allowing a data provider to input their parameters, consistent with exemplary embodiments of the present disclosure;

FIG. 5 is a simplified functional block diagram of a computer and/or server that may be configured as a device or system providing user-specified exchanges for message channel data in an online environment, according to an exemplary embodiment of the present disclosure.

### DETAILED DESCRIPTION

The present disclosure describes systems and methods for providing user-specified exchanges for message channel data. In one exemplary embodiment, a system server is provided that includes databases and a matching engine. The databases receive requests for message channel data from data recipients that may include a number of parameters pertaining to the type of data the data recipients are interested in acquiring. The databases further receive offers of message channel data from a plurality of users, or data providers, which include a number of parameters pertaining to the restrictions on the data the data providers require before they will agree to release their data to the data recipients, if at all. The parameters are generally related to a particular data provider's interest in protecting their privacy, but may reflect other preferences of the data providers. For example, a data provider may choose not to share data with specified entities as a matter of preference.

The database may collect the parameters from substantial numbers of data providers and potential data recipients. A matching engine incorporated into the server system then determines what subset of data providers, if any, satisfy the parameters of each data recipient. If a match is made between a set of data providers and a data recipient, the matching engine stores the particulars of the match in the database and sends a notification to the set of data providers and the data recipient. A fulfillment system then aggregates the message user data from all of the data providers in the matching set, and separates the data into permitted and non-permitted segments based on the parameters set by the data providers and requested by the data recipients. Then it transmits only the permitted segments to the data recipient in accordance with the parameters set by their request. A separate settlement system may be used to provide compensation to the data providers, in the form of monetary renumeration or any other means consistent with the parameters set by the data providers. Each individual data provider may be separately compensated in accordance with their particular parameters.

Data providers may pool the data of many individual users and grant data access to the database comprising a matching engine. Each user selects which data sources it allows access to, and specifies filters to place on data collected. For example, one user may agree to grant access to their email inbox, but only for receipts, and only for the amounts of receipts, items purchased, and company sending the receipt. Another user may agree to grant access to their text message history for all messages including specified terms. Yet another user may agree to grant access to their e-mail and text message history, but only for receipts from specified merchants, e.g., receipts for ridesharing providers. The database may require permission to receive external access to the data or there may be an agreement with a data collecting entity, such as an email provider or web browser supplier, to receive the data.

The matching engine may be used to aggregate the user data and analyze it. The analysis may include trends, analysis by locale and demographics, weighting data for different users to make the data a better reflection of a particular population, and identifying sets of users whose data most effectively predicts different types of trends. For example, an analysis that may be desired and requested by a data recipient is aggregated trend data about users' purchases from different companies, indicating which companies are increasing their revenue and which are decreasing their revenue.

Payments to data providers may be based on the amount of data they contribute and on how useful that data is for making accurate predictions, profitable decisions, or valuable insights. Alternatively, the payments may be based on parameters selected by the individual data providers relating to willingness to bundle their data in a sale. For example, a data provider may indicate a minimum amount they are willing to be paid in exchange for access to their specified data, and that otherwise they do not consent to their data being used and delivered to a potential data recipient.

Reference will now be made in detail to the exemplary embodiments of the disclosure, examples of which are illustrated in the accompanying drawings. Wherever possible, the same reference numbers will be used throughout the drawings to refer to the same or like parts.

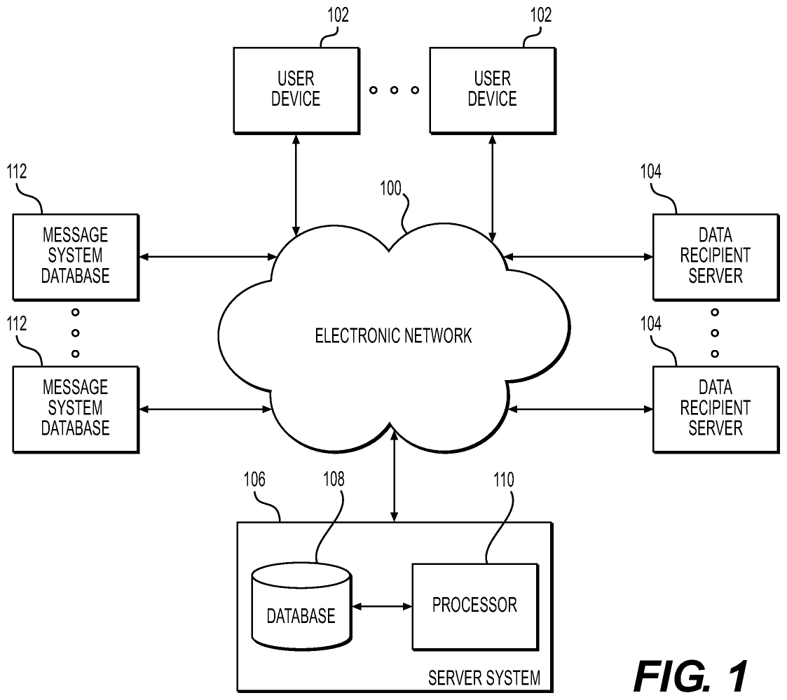

FIG. 1 is a schematic diagram of an exemplary network environment in which various user interfaces may display online content, according to an embodiment of the present disclosure. As shown in FIG. 1, the environment may include a plurality of user or client devices 102 that are communicatively coupled to each other as well as a plurality of server systems 106 via an electronic network 100. Electronic network 100 may include one or a combination of wired and/or wireless electronic networks. Network 100 may also include a local area network, a medium area network, and/or a wide area network, such as the Internet.

In one embodiment, each of user or client devices 102 may be any type of computing device configured to send and receive different types of content and data to and from various computing devices via network 100. Examples of such a computing device include, but are not limited to, a desktop computer or workstation, a laptop computer, a mobile handset, a personal digital assistant (PDA), a cellular telephone, a network appliance, a camera, a smart phone, an enhanced general packet radio service (EGPRS) mobile phone, a media player, a navigation device, a game console, a set-top box, or any combination of these or other types of computing devices having at least one processor, a local memory, a display (e.g., a monitor or touchscreen display), one or more user input devices, and a network communication interface. The user input device(s) may include any type or combination of input/output devices, such as a keyboard, touchpad, mouse, touchscreen, camera, and/or microphone.

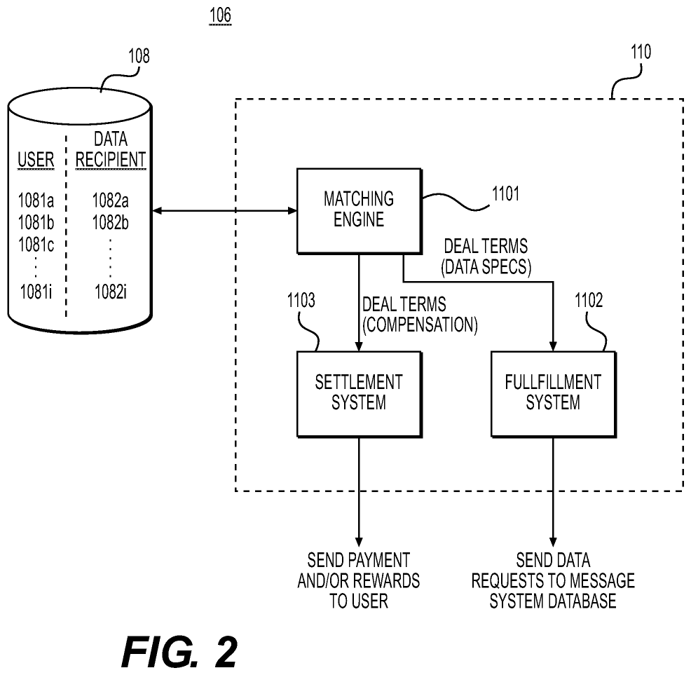

In one embodiment, each of the user or client devices 102 may be configured to execute a web browser or mobile browser installed for displaying various types of content and data received from any of server systems 106 via network 100. Server systems 106 in turn may be configured to receive data related to user interaction with the web browsers or mobile browsers displayed in the user or client devices 102. The user interaction may occur at each device 102 through an interface provided on a webpage loaded within the browser executable at each device. The user interaction may include transfer and receipt of message channel data, which includes e-mail, short message service (SMS) text messaging, instant messaging (IM), social networking messaging, and multimedia message service (MMS) messaging. It should be noted that server systems 106 may be implemented using a single server device or system or may refer to a combination of multiple servers. Additionally, a plurality of data recipient servers 104 may be connected to the electronic network 100 and may be any type of computing device configured to send and receive different types of content and data to and from various computing devices via network 100. Furthermore, a plurality of message system databases 112 may be connected to the electronic network 100 and may be configured to send and receive data in response to commands from the server systems 106. Further details with respect to providing user-specified exchanges for message channel data are provided in FIGS. 2-7.

FIG. 2 shows the server system 106 described in FIG. 1 in greater detail. The server system 106 comprises databases 108 and a plurality of processors 110 that include a matching engine 1101, a fulfillment system 1102, and a settlement system 1103. Matching engine 1101, fulfillment system 1102, and settlement system 1103, may be separate processors 110, or may be components within a single processor 110. The databases 108 collect parameters 1081 from a plurality of data providers and parameters 1082 from a plurality of as of yet potential data recipients.

The matching engine 1101 then determines what subset of data providers, if any, satisfy the parameters of each data recipient. The matching engine 1101 may consider the data recipients' respective parameters one by one in sequence, and upon a match with a data recipient's parameters, remove the message channel data associated with the at least one data provider identified from the match, such that it is not available for transfer to any subsequent data recipients. This method has the advantage of being computationally simple, but it will often result in sub-optimal outcomes for most data providers and data recipients alike.

Alternatively, the matching engine 1101 may use a combinatorial auction method to determine an optimal set of matches between the at least one data recipients and the at least one data providers. Combinatorial auction methods range from the simple to the complex, and involve a tradeoff between computing power and optimization of results. The general steps involved are as follows.

First, each user selects the parameters 1081 for access to their data, which may include data sources it allows access to, and specific filters to place on data collected with respect to preferences and privacy constraints. For example, as discussed above, one user may agree to grant access to their email inbox, but only for receipts, and only for the amounts of receipts, items purchased, and company sending the receipt. Another user may agree to grant access to their text message history for all messages including specified terms. Yet another user may agree to grant access to their e-mail and text message history, but only for receipts from specified merchants, e.g., receipts for ridesharing providers. Furthermore, another parameter 1081 is a compensation amount for access to a data provider's data. The compensation amount may be a sale price or may involve other factors. In an exemplary embodiment, the compensation amount will be limited to a single sale price. For purposes of illustration of the combinatorial auction methods, each set of parameters 1081 from a data provider may be referred to as an “ask.”

Next, each data recipient selects the parameters 1082 for the type and structure of data they would like access to. These parameters may include types of data sources, number of users in the pool of data providers for purposes of trend identification, etc., ensuring there are enough users in the sample for their data to be relevant to their purposes. The data recipients' parameters 1082 may also include a proposed per-use compensation structure that may involve any number of items or services of value, but may also include a specific purchase price. For purposes of illustration of the combinatorial auction methods, each set of parameters 1082 from a data recipient may be referred to as a “bid.”

For each bid, the matching engine 1101 determines the set of asks that minimizes the sum of ask prices and also satisfies the parameters of the data recipient. If there is no such set of asks, then the buyer is informed that their bid cannot be satisfied. To match asks and bids in an optimal manner where there are a plurality of each available requires computational effort and approximations where the computation may be infeasible. Many algorithms have been proposed to solve combinatorial auction method problems and may be applied here.

If a match is made between a set of data providers and a data recipient, the matching engine 1101 communicates the particulars of the match to at least one of databases 108 and sends a notification to the user devices 102 of the set of data providers in the match and to the server 104 of the data recipient in the match. The fulfillment system 1102 then aggregates the message user data from all of the data providers in the matching set, and separates the data into permitted and non-permitted segments based on the parameters 1081 set by the data providers and the parameters 1082 requested by the data recipients. Then the fulfillment system 1102 transmits only the permitted segments to the data recipient server 104 in accordance with the parameters 1082 set by the data recipient in their request. The settlement system 1103 may be used to provide directions for compensation to the data providers 102, in the form of monetary renumeration or any other means consistent with the parameters 1081 set by the data providers. Each individual data provider may be separately compensated in accordance with their particular parameters.

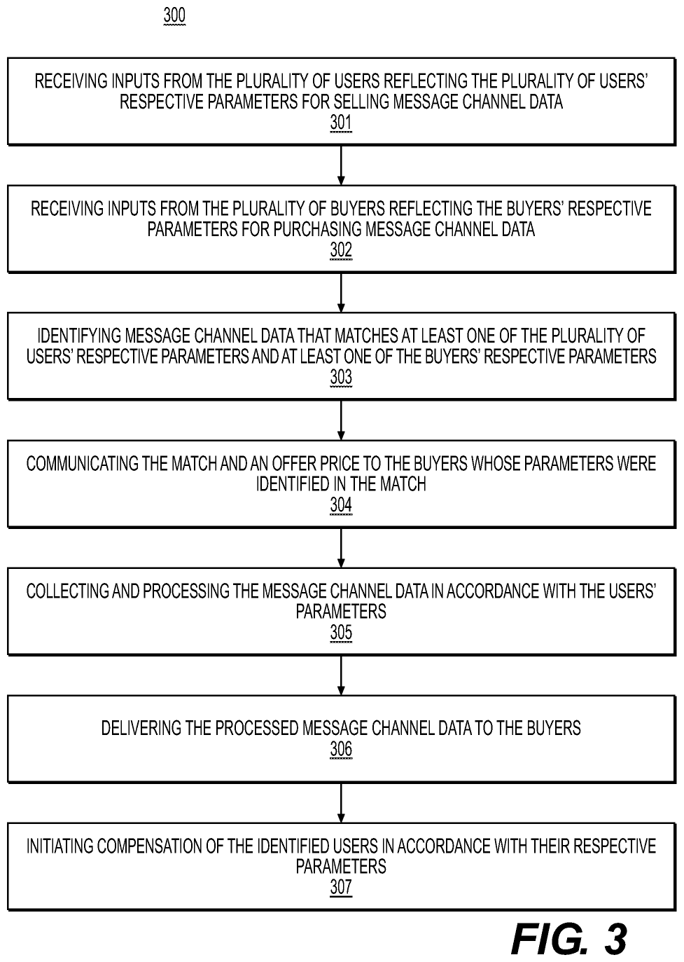

FIG. 3 is an exemplary flow diagram of a method 300 for performing the steps described with reference to FIG. 2 above to provide a user-specified exchange for message channel data. Each of the steps in method 300 are performed at or by the server system 106. In further detail, as shown in FIG. 3, step 301 of method 300 includes receiving inputs from the plurality of data providers via their user devices 102, the inputs comprising the respective parameters for permission to provider their message channel data to prospective data recipients. At step 302 of method 300, inputs are received from a plurality of data recipients that comprise the respective parameters for each of the data recipients. At step 303, the matching engine 1101 matches at least one set of data providers with at least one data recipient, as described in more detail with reference to FIG. 2 above.

If a match is made between a set of data providers and a data recipient, the matching engine 1101 communicates the particulars of the match at step 304 to at least one of databases 108 and sends a notification to the user devices 102 of the set of data providers in the match and to the server 104 of the data recipient in the match. Then, in step 305, the fulfillment system 1102 aggregates the message user data from all of the data providers in the matching set, and separates the data into permitted and non-permitted segments based on the parameters 1081 set by the data providers and the parameters 1082 requested by the data recipients. At step 306, the fulfillment system 1102 transmits only the permitted segments to the data recipient server 104 in accordance with the parameters 1082 set by the data recipient in their request. At step 307, the settlement system 1103 may be used to provide directions for compensation to the data providers 102, in the form of monetary renumeration or any other means consistent with the parameters 1081 set by the data providers. Each individual data provider may be separately compensated in accordance with their particular parameters.

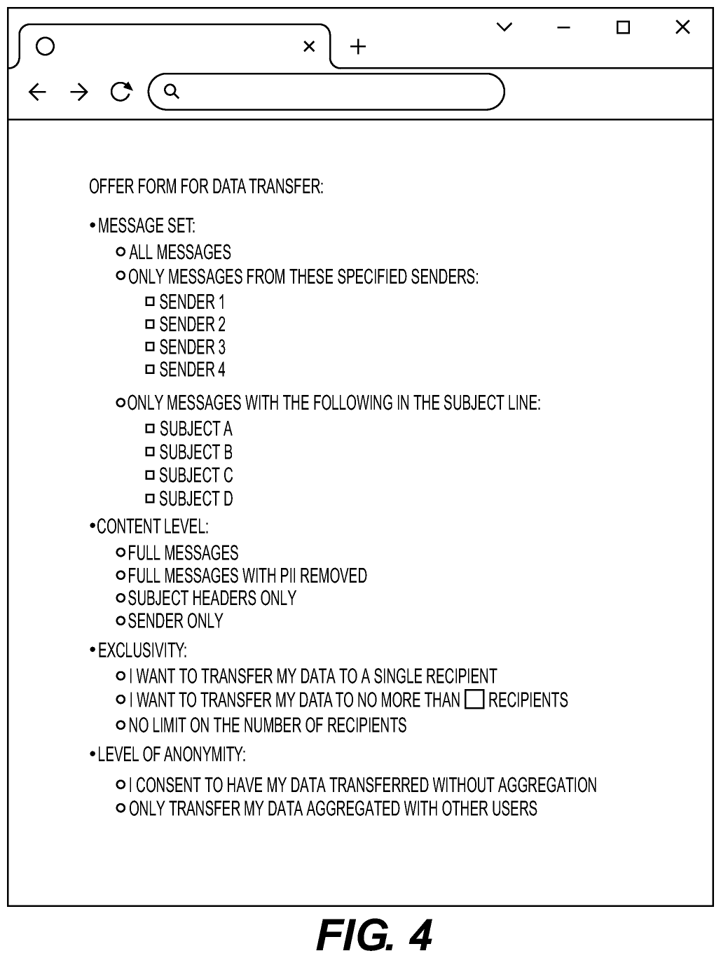

FIG. 4 displays an exemplary user interface to be displayed on a user device 102 for a data provider to input their parameters regarding their message channel data being sent to potential data recipients. These parameters are merely exemplary and are not exhaustive of the possible parameters to be considered and selected. For example, a data provider may indicate whether they want all of their messages to be part of an available message channel data set, or only messages to specified senders, or only message with specific words in the subject line, etc. The data providers may also elect to have their personally identifiable information removed, the body of messages removed (i.e., send only subject headers to be included in the message channel data set), or have all information removed but for the recipient of the message. Furthermore, a user may elect to include a parameter relating to the level of exclusivity, e.g., the number of data recipients that will have access to their message channel data within the message channel data set they receive. For example, a data provider may elect to exclude specific data recipients, or to limit the number of data recipients that receive their message channel data. A data provider may also include a parameter relating to the level of anonymity provided their message channel data. For example, a data provider may choose to elect to only include their message channel data if it is aggregated with other data providers to provide a statistical model.

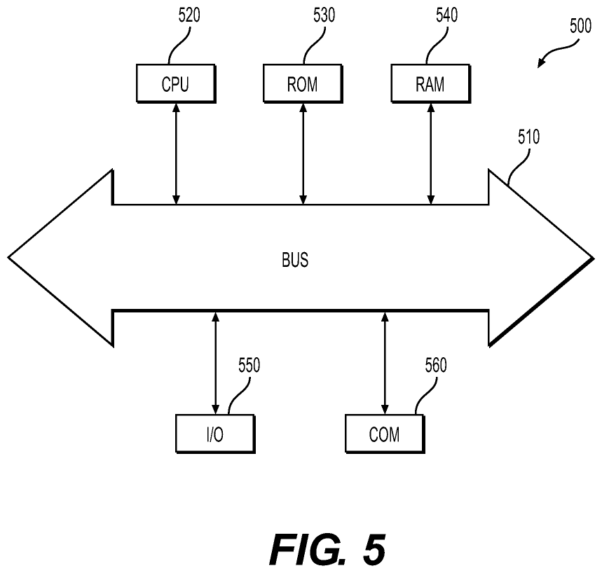

FIG. 5 illustrates a high-level functional block diagram of an exemplary computer system 500, in which embodiments of the present disclosure, or portions thereof, may be implemented, e.g., as computer-readable code. For example, each of the exemplary devices and systems described above with respect to FIG. 1 can be implemented in computer system 500 using hardware, software, firmware, tangible computer readable media having instructions stored thereon, or a combination thereof and may be implemented in one or more computer systems or other processing systems. Hardware, software, or any combination of such may embody any of the modules and components in FIG. 1, as described above.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the present disclosure, as described above in the examples of FIGS. 1-4 may be implemented using computer system 500, shown in FIG. 5. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 5, computer system 500 includes a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 is connected to a data communication infrastructure 510, for example, a bus, message queue, network, or multi-core message-passing scheme.

Computer system 500 also includes a main memory 540, for example, random access memory (RAM), and may also include a secondary memory 530. Secondary memory 530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc. which is read by and written to by the removable storage drive. As will be appreciated by persons skilled in the relevant art, such a removable storage unit generally includes a computer usable storage medium having stored therein computer software and/or data.

In alternative implementations, secondary memory 530 may include other similar means for allowing computer programs or other instructions to be loaded into computer system 500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to computer system 500.

Computer system 500 may also include a communications interface (“COM”) 560. Communications interface 560 allows software and data to be transferred between computer system 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical, or other signals capable of being received by communications interface 560. These signals may be provided to communications interface 560 via a communications path of computer system 500, which may be implemented using, for example, wire or cable, fiber optics, a phone line, a cellular phone link, an RF link or other communications channels.

The hardware elements, operating systems, and programming languages of such equipment are conventional in nature, and it is presumed that those skilled in the art are adequately familiar therewith. Computer system 500 also may include input and output ports 550 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for exchanging message channel data between at least one of a plurality of data providers and at least one of a plurality of data recipients, the method comprising:
receiving, using at least one processor, inputs from the plurality of data providers comprising the plurality of data providers' respective parameters for providing message channel data, the data providers' parameters including permitted data segments and non-permitted data segments;
receiving, using the at least processor, inputs from the plurality of data recipients comprising the data recipients' respective parameters for receiving message channel data;
identifying, using a matching engine, message channel data that matches the parameters of at least one of the plurality of data providers and the parameters of at least one of the data recipients;
communicating the match to the data recipients whose parameters were identified in the match;
collecting the message channel data that was identified in the match;
processing the message channel data in accordance with the parameters of the data providers whose parameters were identified in the match, the processing step comprising segmenting the message channel data into the permitted data segments and the non-permitted data segments based on the data providers' parameters;
delivering the permitted data segments to the identified data recipients in accordance with their respective parameters; and
initiating a request for compensation of the identified data providers in accordance with their respective parameters.

2. The method as recited in claim 1, wherein the data providers' parameters include at least one of:
identification of a message set;
identification of a content level;
identification of exclusivity of the message set;
identification of identifying information within the message set;
level of anonymity;
time period when the message data is to be available; or
compensation requests for providing access to the message set.

3. The method as recited in claim 2, wherein the processing step further includes aggregating statistics regarding the message channel data and/or removing personally identifiable information or other information from the message channel data to ensure that the message channel data delivered to the identified data recipients is in compliance with the parameters set by the identified data providers.

4. The method as recited in claim 1, wherein the identifying step comprises considering data recipients' respective parameters one by one in sequence, and upon a match between a data recipient's parameters and the at least one data provider's parameters, the message channel data associated with the at least one data provider identified from the match is removed.

5. The method as recited in claim 1, wherein the identifying step comprises using a combinatorial auction method to determine an optimal set of matches between the at least one data recipients and the at least one data providers.

6. The method as recited in claim 1, wherein the message channel data is any combination of e-mail, short message service (SMS) text messaging, instant messaging (IM), social networking messaging, and multimedia message service (MMS) messaging.

7. The method as recited in claim 1, wherein the step of communicating the match to the data recipients comprises sending a notification to a user device.

8. A system for exchanging message channel data between at least one of a plurality of data providers and at least one of a plurality of data recipients, the system comprising:
a data storage device storing instructions; and
a processor configured to execute the instructions to perform a method comprising:
receiving, using at least one processor, inputs from the plurality of data providers reflecting the plurality of data providers' respective parameters for selling message channel data, the data providers' parameters including permitted data segments and non-permitted data segments;
receiving, using the at least processor, inputs from the plurality of data recipients reflecting the data recipients' respective parameters for purchasing message channel data;
identifying, using a matching engine, message channel data that matches at least one of the plurality of data providers' respective parameters and at least one of the data recipients' respective parameters;
communicating the match to the data recipients whose parameters were identified in the match;
collecting the message channel data that was identified in the match;
processing the message channel data in accordance with the parameters of the data providers whose parameters were identified in the match, the processing step comprising segmenting the message channel data into the permitted data segments and the non-permitted data segments;
delivering the permitted data segments to the identified data recipients in accordance with their respective parameters; and
initiating a request for compensation of the identified data providers in accordance with their respective parameters.

9. The system as recited in claim 8, wherein the data providers' parameters include at least one of:
identification of a message set;
identification of a content level;
identification of exclusivity of the message set;
identification of identifying information within the message set;
level of anonymity;
time period when the message data is to be available; or
compensation requests for providing access to the message set.

10. The system as recited in claim 9, wherein the processing step further includes aggregating statistics regarding the message channel data and/or removing personally identifiable information or other information from the message channel data to ensure that the message channel data delivered to the identified data recipients is in compliance with the parameters set by the identified data providers.

11. The system as recited in claim 8, wherein the identifying step comprises considering data recipients' respective parameters one by one in sequence, and upon a match between a data recipient's parameters and the at least one data provider's parameters, the message channel data associated with the at least one data provider identified from the match is removed.

12. The system as recited in claim 8, wherein the identifying step comprises using a combinatorial auction method to determine an optimal set of matches between the at least one data recipients and the at least one data providers.

13. The system as recited in claim 8, wherein the message channel data is any combination of e-mail, short message service (SMS) text messaging, instant messaging (IM), social networking messaging, and multimedia message service (MMS) messaging.

14. The system as recited in claim 8, wherein communicating the match to the data recipients comprises sending a notification to a user device.

15. A non-transitory computer-readable medium storing instructions, the instructions, when executed by a computer system cause the computer system to perform a method, the method comprising:
receiving, using at least one processor, inputs from the plurality of data providers reflecting the plurality of data providers' respective parameters for selling message channel data, the data providers' parameters including permitted data segments and non-permitted data segments;
receiving, using the at least processor, inputs from the plurality of data recipients reflecting the data recipients' respective parameters for purchasing message channel data;
identifying, using a matching engine, message channel data that matches at least one of the plurality of data providers' respective parameters and at least one of the data recipients' respective parameters;
communicating the match to the data recipients whose parameters were identified in the match;
collecting the message channel data that was identified in the match;
processing the message channel data in accordance with the parameters of the data providers whose parameters were identified in the match, the processing step comprising segmenting the message channel data into the permitted data segments and the non-permitted data segments;
delivering the permitted data segments to the identified data recipients in accordance with their respective parameters; and
initiating a request for compensation of the identified data providers in accordance with their respective parameters.

16. The non-transitory computer-readable medium as recited in claim 15, wherein the data providers' parameters include at least one of:
identification of a message set;
identification of a content level;
identification of exclusivity of the message set;
identification of identifying information within the message set;
level of anonymity;
time period when the message data is to be available; or
compensation requests for providing access to the message set.

17. The non-transitory computer-readable medium as recited in claim 16, wherein the processing step further includes aggregating statistics regarding the message channel data and/or removing personally identifiable information or other information from the message channel data to ensure that the message channel data delivered to the identified data recipients is in compliance with the parameters set by the identified data providers.

18. The non-transitory computer-readable medium as recited in claim 15, wherein the identifying step comprises considering data recipients' respective parameters one by one in sequence, and upon a match, the message channel data associated with the at least one data provider identified from the match is removed.

19. The non-transitory computer-readable medium as recited in claim 15, wherein the identifying step comprises using a combinatorial auction method to determine an optimal set of matches between the at least one data recipients and the at least one data providers.

20. The non-transitory computer-readable medium as recited in claim 15, wherein the message channel data is any combination of e-mail, short message service (SMS) text messaging, instant messaging (IM), social networking messaging, and multimedia message service (MMS) messaging.
